(19) United States
(12) Patent Application Publication
(10) Pub. No.: US 2008/0284917 A1
(43) Pub. Date: Nov. 20, 2008

(54) Digital broadcasting receiving apparatus

(75) Inventor: Yasuhiro Inui, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/149,732

(22) Filed: May 7, 2008

(30) Foreign Application Priority Data
May 15, 2007 (JP) 2007-128844

(51) Int. Cl. H04N 9/64

(52) U.S. Cl. 348/721

(57) ABSTRACT

A digital broadcasting receiver which updates a channel map in adequate timing, is provided with a channel storage portion which stores in advance physical number information which is numerical information to identify a receivable physical channel, and virtual major channel number information which is numerical information of a virtual channel that corresponds to the physical channel in corresponded manner with each other, and a MPU is provided with a channel setting portion which sets a physical channel to be received, a virtual information obtaining portion which obtains the virtual major channel number information that corresponds to the physical channel via a receiving portion, a number judging portion which judges whether or not the obtained virtual major channel number information agrees with the virtual major channel number information which is stored in the channel storage portion, and a number updating portion which writes the obtained virtual major channel number information in the channel storage portion in case where it is judged that these virtual major channel number information do not agree with each other.

This application is based on Japanese Patent Application No. 2007-128844 filed on May 15, 2007, and the contents of which are hereby incorporated by reference.

### BACKGROUND OF THE INVENTION

1. Field of the Invention

The present invention relates to a digital broadcasting receiving apparatus which is connected in communicatable manner with a monitor, receives a television program in digital method, and outputs the received video information to the monitor in visible form from outside.

2. Description of Related Art

In a digital broadcasting receiving apparatus which is connected in communicatable manner with a monitor, receives a television program in digital method, and outputs the received video information to the monitor in visible form from outside, in order to perform channel selection easily, various methods, apparatuses and the like are proposed to generate or update a channel map storing various information relating to receivable channels, for example, physical channel number information, sub channel number information.

For example, a receiving apparatus in which when a channel is registered in the channel map, it is registered in unit of a physical channel, and when a channel is deleted from the channel map, it is deleted in unit of a sub channel, is disclosed (See, JP-A-2002-344832). According to the receiving apparatus, labor that is required to register a channel in the channel map is suppressed and only channels that are fit for user's preference can be registered in the channel map.

However, in the above described receiving apparatus, if channel structure (for example, number of sub channels that are included in the respective physical channels, and the like) is changed by a broadcast station, there may be cases where it becomes difficult to view programs which user requires. That is, when the channel information which is broadcasted is changed and becomes different from the channel information which is registered in the channel map, it becomes necessary to search again the channel in which the program the user requires to view is broadcasted in order to view the program which the user requires to view because the channel map cannot be used anymore without updating it, therefore, it causes a problem in operability.

### SUMMARY OF THE INVENTION

The present invention is made in view of the above described problem, and it is an object of the present invention to provide a digital broadcasting receiving apparatus which can update a channel map in adequate timing.

To attain the above described object, a digital broadcasting receiving apparatus in accordance with a first aspect of the present invention is characterized in that the apparatus is connected in communicatable manner with a monitor, receives a television program in digital method, and outputs the received video information to the monitor in visible form from outside, and the apparatus includes: a channel storage unit which stores in advance physical number information which is numerical information to identify a receivable physical channel, sub number information which is numerical information to identify sub channel included in the physical channel, virtual major channel number information which is numerical information of a virtual channel that corresponds to the physical channel, and virtual minor channel number information which is numerical information of a virtual channel that corresponds to the sub channel, as a channel map in which these information are arranged in corresponded manner with each other; a receiving unit that receives a television program in digital method; a channel setting unit which receives an operating input from outside, and sets a physical channel which is received via the receiving unit based on the received operating input; a virtual information obtaining unit which obtains the virtual major channel number information that corresponds to the physical channel which is set by the channel setting unit via the receiving unit; a number judging unit which judges whether or not the virtual major channel number information which is obtained by the virtual information obtaining unit, agrees with the virtual major channel number information which is stored in the channel storage unit; and a number updating unit which writes the virtual major channel number information which is obtained by the virtual information obtaining unit in the channel storage unit and updates the channel map in case where it is judged by the number judging unit that these virtual major channel number information do not agree with each other.

The digital broadcasting receiving apparatus in accordance with a second aspect of the present invention is characterized in that the virtual information obtaining unit may obtain a Virtual Channel Table (VCT) via the receiving unit, and may obtain the virtual major channel number information by extracting the virtual major channel number information from information included in the obtained VCT in the digital broadcasting receiving apparatus in accordance with the above described first aspect of the present invention.

The digital broadcasting receiving apparatus in accordance with a third aspect of the present invention is characterized in that the virtual information obtaining unit may obtain sub number information which indicates number of sub channels which are included in the physical channel that is set by the channel setting unit, the number judging unit may judge whether or not the number of the sub channels which is indicated by the sub number information that is obtained by the virtual information obtaining unit, agrees with the number of the sub channels which is stored in the channel storage unit, in case where it is judged by the number judging unit that the numbers do not agree with each other, the virtual information obtaining unit may obtain virtual minor channel number information which corresponds to the sub channel that is included in the physical channel, and the number updating unit may write the virtual minor channel number information which is obtained by the virtual information obtaining unit in the channel storage unit and may update the channel map in the digital broadcasting receiving apparatus in accordance with any of the above described first or second aspect of the present invention.

The digital broadcasting receiving apparatus in accordance with a fourth aspect of the present invention is characterized in that the virtual information obtaining unit may obtain virtual minor channel number information which corresponds to the sub channels which are included in the physical channel that is set by the channel setting unit, the number judging unit may judge whether or not the virtual minor channel number information that is obtained by the virtual information obtaining unit, agrees with the virtual minor channel number information which is stored in the channel storage unit, in case where it is judged by the number judging unit that these virtual minor channel number information do not agree with each other, the number updating unit may write the virtual minor channel number information which is obtained by the virtual information obtaining unit in the channel storage unit and may update the channel map in the digital broadcasting receiving apparatus in accordance with any of the above described first to third aspect of the present invention.

The digital broadcasting receiving apparatus in accordance with a fifth aspect of the present invention is characterized in that the channel storage unit may store in advance virtual name information which is name information of a virtual channel that corresponds to the sub channel in corresponded manner with each other, the virtual information obtaining unit may obtain virtual name information which corresponds to the sub channel that is included in the physical channel which is set by the channel setting unit, the number judging unit may judge whether or not the virtual name information which is obtained by the virtual information obtaining unit, agrees with virtual name information which is stored in the channel storage unit, and in case where it is judged by the number judging unit that these information do not agree with each other, the number updating unit may write the virtual name information which is obtained by the virtual information obtaining unit in the channel storage unit and may update the channel map in the digital broadcasting receiving apparatus in accordance with any of the above described first to fourth aspect of the present invention.

The digital broadcasting receiving apparatus in accordance with a sixth aspect of the present invention may include an updating process ordering unit which displays information that urges user to execute a process for updating the whole channel map that is stored in the channel storage unit on the monitor in case where it is judged by the number judging unit that these information do not agree with each other in the digital broadcasting receiving apparatus in accordance with any of the above described first to fourth aspect of the present invention.

In the digital broadcasting receiving apparatus in accordance with the first aspect of the present invention, physical number information which is numerical information to identify a receivable physical channel, sub number information which is numerical information to identify sub channel included in the physical channel, virtual major channel number information which is numerical information of a virtual channel that corresponds to the physical channel, and virtual minor channel number information which is numerical information of a virtual channel that corresponds to the sub channel are stored in advance in a channel storage unit as a channel map in which these information are arranged in corresponded manner with each other. Then, an operating input from outside is received, a physical channel which is received via the receiving unit is set based on the received operating input, and virtual major channel number information that corresponds to the physical channel, is obtained. Further, it is judged whether or not the virtual major channel number information which is obtained, agrees with the virtual major channel number information which is stored in the channel storage unit, and the virtual major channel number information which is obtained is written in the channel storage unit and the channel map is updated in case where it is judged by the number judging unit that these virtual major channel number information do not agree with each other. As a result, the channel structure can be updated in adequate timing.

That is, because in case where it is judged that the obtained virtual major channel number information does not agree with the virtual major channel number information which is stored in the channel storage unit, the obtained virtual major channel number information is written in the channel storage unit, the channel map is updated, and it is not necessary for user to order a process for updating the virtual major channel number information which is included in the channel map, the channel structure can be updated in adequate timing.

In the digital broadcasting receiving apparatus in accordance with the second aspect of the present invention, because the VCT (Virtual Channel Table) is obtained via the receiving unit, and the virtual major channel number information is obtained by extracting the virtual major channel number information from information which is included in the obtained VCT, the channel structure can be easily updated in adequate timing.

That is, because the VCT is obtained, the virtual major channel number information is obtained by extracting the virtual major channel number information from information which is included in the obtained VCT, and the virtual major channel number information is included in the VCT, the virtual major channel number information can be easily obtained.

In the digital broadcasting receiving apparatus in accordance with the third aspect of the present invention, sub number information which indicates number of sub channels which are included in the set physical channel, is obtained, and it is judged whether or not the number of the sub channels which is indicated by the sub number information that is obtained, agree with the number of the sub channels which is stored in the channel storage unit. Then, in case where it is judged that the numbers do not agree with each other, the virtual minor channel number information which corresponds to the sub channel that is included in the physical channel, is obtained, the virtual minor channel number information which is obtained is written in the channel storage unit and the channel map is updated. As a result, the channel structure can be updated in more adequate timing.

That is, because in case where it is judged that the number of the sub channels which is indicated by the obtained sub number information does not agree with the number of the sub channels which is stored in the channel storage unit, the virtual minor channel number information which corresponds to the sub channel that is included in the physical channel is obtained, the obtained virtual minor channel number information is written in the channel storage unit, the channel map is updated, and it is not necessary for user to order the process for updating the virtual minor channel number information which is included in the channel map, the channel structure can be updated in more adequate timing.

In the digital broadcasting receiving apparatus in accordance with the fourth aspect of the present invention, the virtual minor channel number information which corresponds to the sub channels which are included in the set physical channel, is obtained, and it is judged whether or not the obtained virtual minor channel number information agrees with the virtual minor channel number information which is stored in the channel storage unit. Then, in case where it is judged that these number information do not agree with each other, the obtained virtual minor channel number information is written in the channel storage unit and the channel map is updated. As a result, the channel structure can be updated in more adequate timing.

That is, because in case where it is judged that the obtained virtual minor channel number information does not agree with the virtual minor channel number information which is stored in the channel storage unit, the obtained virtual minor channel number information is written in the channel storage unit, the channel map is updated, and it is not necessary for user to order the process for updating the virtual minor channel number information which is included in the channel map, the channel structure can be updated in more adequate timing.

In the digital broadcasting receiving apparatus in accordance with the fifth aspect of the present invention, the virtual name information which is name information of a virtual channel that corresponds to the sub channel is stored in advance in the channel storage unit in corresponded manner with each other. Further, the virtual name information which corresponds to the sub channel that is included in the set physical channel, is obtained, and it is judged whether or not the obtained virtual name information agrees with the virtual name information which is stored in the channel storage unit. Then, in case where it is judged that these virtual name information do not agree with each other, the obtained virtual name information is written in the channel storage unit and the channel map is updated. As a result, the channel structure can be updated in more adequate timing.

That is, because in case where it is judged that the obtained virtual name information does not agree with the virtual name information which is stored in the channel storage unit, the obtained virtual name information is written in the channel storage unit, the channel map is updated, and it is not necessary for user to order the process for updating the virtual name information which is included in the channel map, the channel structure can be updated in more adequate timing.

In the digital broadcasting receiving apparatus in accordance with the sixth aspect of the present invention, because in case where it is judged that the obtained information does not agree with the information which is stored in the channel storage unit, information that urges user to execute the process for updating the channel map that is stored in the channel storage unit, is displayed on the monitor, the whole channel map can be updated in adequate timing.

That is, because in case where it is judged that the obtained information does not agree with the information which is stored in the channel storage unit, information that urges user to execute the process for updating the whole channel map that is stored in the channel storage unit is displayed on the monitor, and the user can view timing to execute the process for updating the whole channel map, the whole channel map can be updated in adequate timing.

### BRIEF DESCRIPTION OF THE DRAWINGS

FIG. 1 is a block diagram to show one example of a structure of a digital broadcasting receiver according to one embodiment of the present invention;

FIG. 2 is a block diagram to show one example of a structure of a main part of a digital broadcasting receiver according to one embodiment of the present invention;

FIG. 3 is a table to show one example of a channel map which is stored in a channel storage portion in a digital broadcasting receiver according to one embodiment of the present invention;

FIG. 4 is a flow chart to show one example of operation of an MPU in a digital broadcasting receiver according to one embodiment of the present invention; and

FIG. 5 is a diagram of a screen to show one example of a screen to order updating which is displayed on a display in step S117 of the flow chart shown in FIG. 4.

### DETAILED DESCRIPTION OF PREFERRED EMBODIMENTS

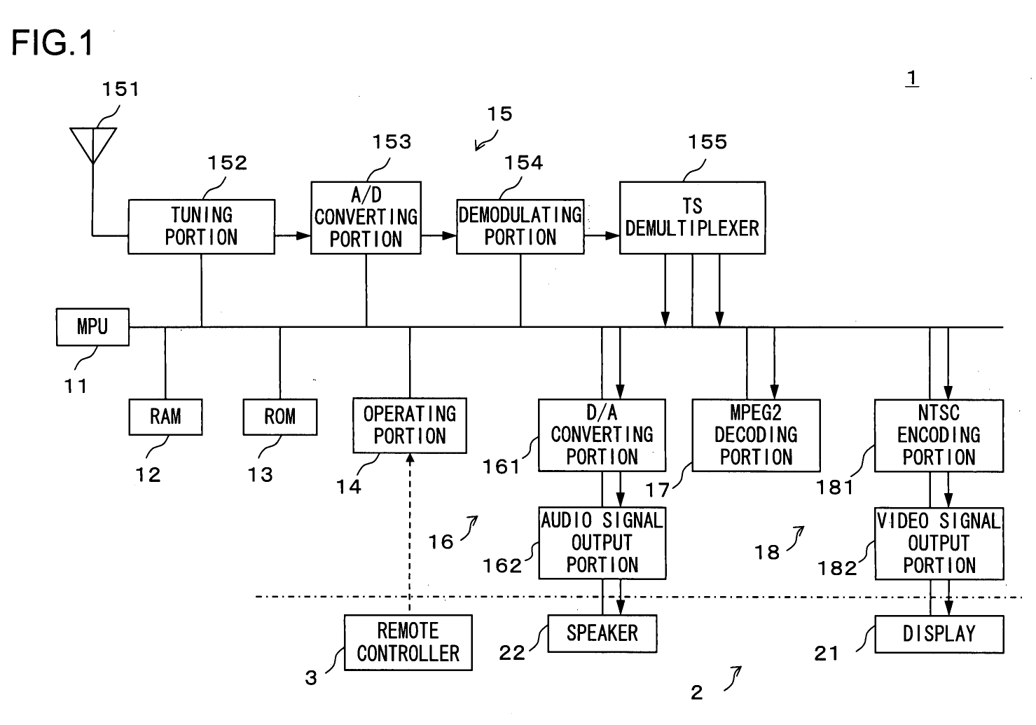

Hereinafter an embodiment of the present invention will be explained with reference to drawings. FIG. 1 is a block diagram to show one example of a structure of a digital broadcasting receiver according to one embodiment of the present invention. The digital broadcasting receiver 1 (corresponding to a digital broadcasting receiving apparatus) is connected in communicatable manner with an output device 2, and it is also connected in communicatable manner with a remote controller 3 via an infrared data communication.

The digital broadcasting receiver 1 receives an operating input from a user via the remote controller 3, and based on the received operating input, it receives a television program in digital method. The digital broadcasting receiver 1 displays the received video information on a display 21 and at the same time it outputs the received audio information to a speaker 22.

The output device 2 is provided with the display 21 and the speaker 22 to output the audio information and the video information which are input from the digital broadcasting receiver 1. The display 21 (corresponding to a monitor) is provided with a Liquid Crystal Display (LCD), a Plasma Display Panel (PDP), or the like to display the video information which is input from the digital broadcasting receiver 1 such that the information can be seen from outside. The speaker 22 outputs the audio information which is input from the digital broadcasting receiver 1.

The remote controller 3 (corresponding to a part of a channel setting unit) receives an operating input from the user, generates an infrared signal which corresponds to the received operating input, and outputs it to the digital broadcasting receiver 1.

The digital broadcasting receiver 1 is provided with an MPU 11, a RAM 12, a ROM 13, an operating portion 14, a receiving portion 15, an audio output portion 16, an MPEG2 decoding portion 17, and a video output portion 18.

The Micro Processing Unit (MPU) 11 controls whole operation of the digital broadcasting receiver 1. The Random Access Memory (RAM) 12 stores information such as the audio information, the video information, and the like in readable and writable manner. The Read Only Memory (ROM) 13 stores control program and the like to operate the MPU 11.

The operating portion 14 receives various kinds of operating commands such as ON-OFF operation of electric power, tuning, and the like. The operating portion 14 receives the operating signal from the remote controller 3 via infrared data communication to receive the various operating commands. The receiving portion 15 (corresponding to a receiving unit) is provided with an antenna portion 151, a tuning portion 152, an A/D converting portion 153, a demodulating portion 154, and a TS demultiplexer 155 to receive and demodulate the television program.

The antenna portion 151 receives a television program wave. The tuning portion 152 selects a broadcast of a channel which is set in advance (or received via the remote controller 3) from the television program wave that is received by the antenna portion 151. The A/D converting portion 153 converts an output signal from the tuning portion 152 (analog signal) into digital information. The demodulating portion 154 demodulates the output information from the A/D converting portion 153. The Transport Stream (TS) demultiplexer 155 separates the demodulated output information by the demodulating portion 154 for every type and outputs them.

The audio output portion 16 is provided with a D/A converting portion 161, and an audio signal output portion 162 to output an audio signal which corresponds to the television program that is received by the receiving portion 15 to the speaker 22. The D/A converting portion 161 converts the audio signal which is output from the TS demultiplexer 155 (digital information) into analog signal. The audio signal output portion 162 outputs the audio signal which is converted into the analog signal by the D/A converting portion 161 to the speaker 22.

The Motion Picture Experts Group (MPEG) 2 decoding portion 17 decodes the video information which is output from the TS demultiplexer 155 to video information that is before compression.

The video output portion 18 is provided with an NTSC encoding portion 181 and a video signal output portion 182 to output the video signal which is decoded by the MPEG2 decoding portion 17 to the display 21. The National Television Standards Committee (NTSC) encoding portion 181 converts the video signal which is decoded by the MPEG2 decoding portion 17 into a television signal of NTSC system. The video signal output portion 182 outputs the television signal of NTSC system which is output from the NTSC encoding portion 181 to the display 21.

Next, explanation will be given about operation when the digital broadcasting receiver 1 receives a broadcast. First, digital broadcast wave which is sent is received by the antenna portion 151. When channel selecting operation is received via the operating portion 14 (or remote controller 3), change of transponder through which the broadcast is received, is performed by the tuning portion 152. The digital broadcast wave which is received is converted into digital information by the A/D converting portion 153 and demodulated by the demodulating portion 154.

The digital broadcast wave is transmitted as TS packet from the transmitting side (broadcasting station). The TS packet includes video information, audio information, control information, and the like, and these information are separated and output by the TS demultiplexer 155 to be stored in the RAM 12. Then, the audio information which is read out from the RAM 12 is converted into analog signal by the D/A converting portion 161, and the sound is output from the speaker 22 via the audio signal output portion 162.

Further, the video information which is read out from the RAM 12 is decoded into video information that is before compression by the MPEG2 decoding portion 17. The decoded video information is converted into the television signal in NTSC system by the NTSC encoding portion 181, and video image is displayed on the display 21 via the video signal output portion 182.

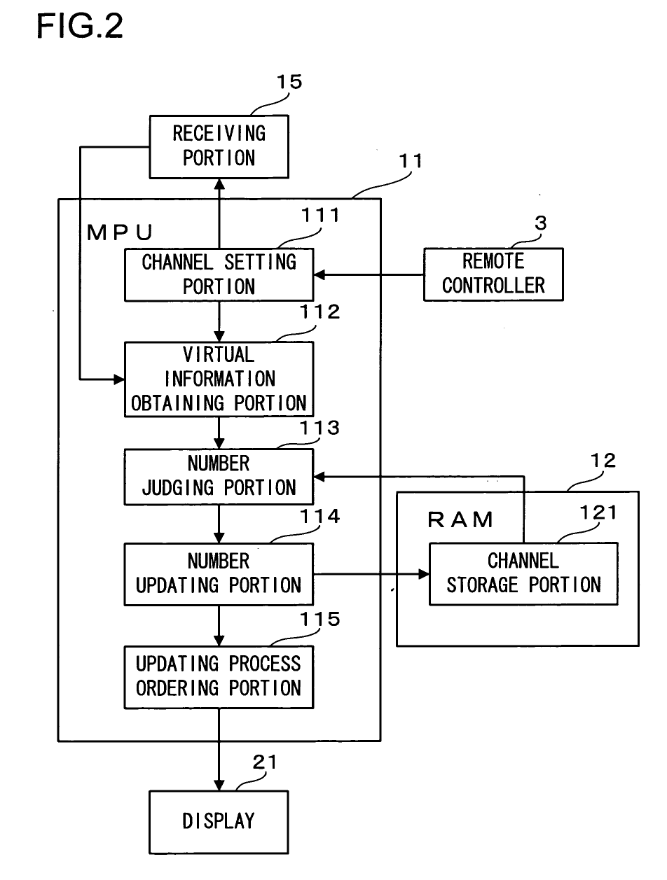

FIG. 2 is a block diagram to show one example of a structure of a main part of a digital broadcasting receiver 1 according to one embodiment of the present invention. The MPU 11 is provided with a channel setting portion 111, a virtual information obtaining portion 112, a number judging portion 113, a number updating portion 114, and the updating process ordering portion 115 as function portions. The RAM 12 is provided with a channel storage portion 121 as a function portion.

In the present embodiment, the MPU 11 works as the function portions of the channel setting portion 111, the virtual information obtaining portion 112, the number judging portion 113, the number updating portion 114, an updating process ordering portion 115, and the like by reading a control program which is stored in advance in the ROM 13 or the like that is shown in FIG. 1, and by executing it, and at the same time it makes the RAM 12 function as the function portion of the channel storage portion 121 or the like.

Further, among various kinds of data which are stored in the RAM 12 or the ROM 13 that is shown in FIG. 1, data that can be stored in a detachable recording medium, may be made readable in a driver such as a hard disk drive, an optical disc drive, a flexible disk drive, a silicon disc drive, a cassette medium reader, and the like, for example. In such case, the recording medium is, for example, a hard disk, an optical disc, a flexible disk, a compact disc (CD), a digital versatile disc (DVD), a semiconductor memory, and the like.

The channel storage portion 121 (corresponding to a channel storage unit) stores in advance physical number information which is numerical information to identify a physical channel that is receivable, sub number information which is numerical information to identify sub channels that are included in the physical channel, virtual major channel number information which is numerical information of a virtual channel that corresponds to the physical channel, virtual minor channel number information which is numerical information of a virtual channel that corresponds to the sub channel, and virtual name information which is name information of a virtual channel that corresponds to the sub channel as a channel map in which these information are arranged in corresponded manner with each other.

Further, the virtual major channel number information, the virtual minor channel number information, and the virtual name information which are stored in the channel storage portion 121, are read out by he number judging portion 113 and updated by the number updating portion 114. That is, the information are overwritten by information which is obtained by the virtual information obtaining portion 112 that will be described later.

Further, the channel map which is stored in the channel storage portion 121, is generated as a whole, or is updated as a whole by executing so called an Auto Scan process. At this point the term Auto Scan process means a process in that a receiving portion 15 is set for every receivable physical channel in order to receive corresponding broadcast, the sub number information, the virtual major channel number information, the virtual minor channel number information, and the virtual name information which correspond to the physical channel that is set, are obtained, and they are stored as the channel map in the channel storage portion 121.

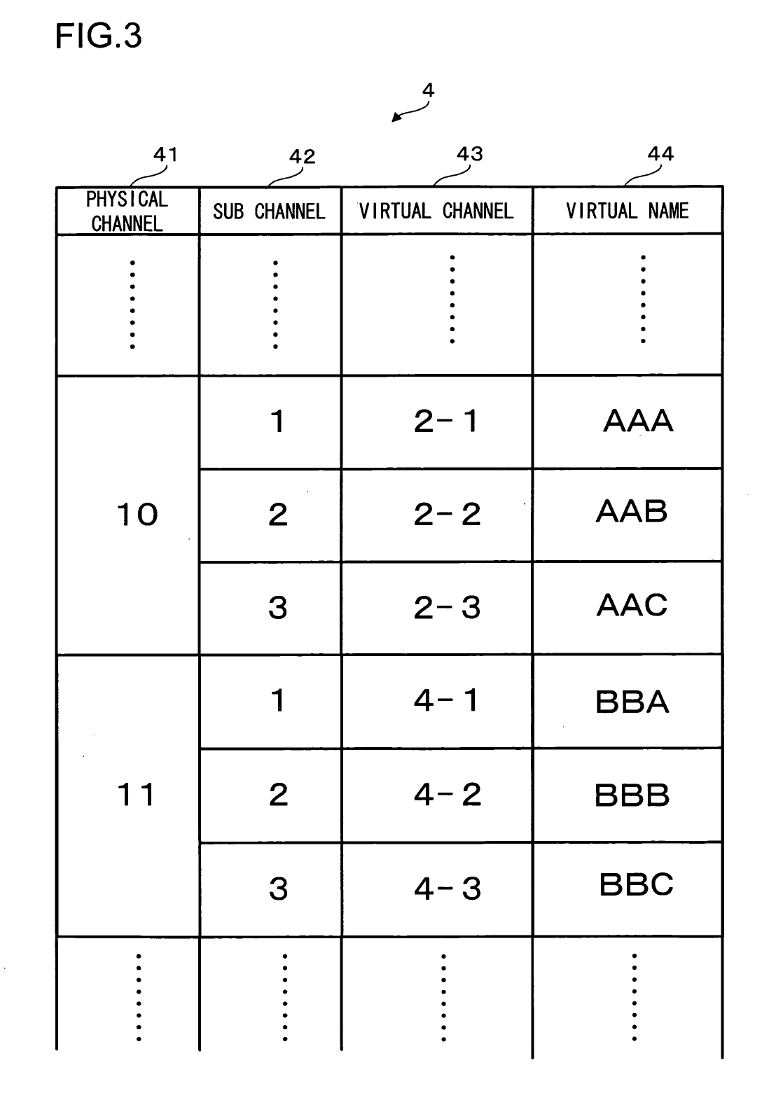

FIG. 3 is a table to show one example of a channel map which is stored in the channel storage portion 121 in a digital broadcasting receiver according to one embodiment of the present invention. In the channel map 4, the physical channel number 41, sub channel number 42, virtual channel number 43, and the virtual name 44 are stored in corresponded manner with each other. In the present embodiment, virtual channel number 43 is formed by combination of the virtual major channel number and the virtual minor channel number with hyphenation.

For example, in a broadcast which has the physical channel number of “10”, three sub channels whose sub channel numbers are “1”-“3”, are contained, and the virtual channel number of the sub channel which has the sub channel number “1” is set as “2-1”, that is, the virtual major channel number is set as “2”, the virtual minor channel number is set as “1”, and the virtual name is set as “AAA”.

Now back to FIG. 2 again, explanation will be given about functional structure of the MPU 11. The channel setting portion 111 (corresponding to a part of the channel setting unit) receives an operating input from user via the remote controller 3, and based on the received operating input, it sets a physical channel which is received via the receiving portion 15.

The virtual information obtaining portion 112 (corresponding to a virtual information obtaining unit) obtains the virtual major channel number information which corresponds to the physical channel that is set by the channel setting portion 111, the sub number information which indicates number of sub channels, the virtual minor channel number information, and the virtual name information via the receiving portion 15.

To be more concrete, the virtual information obtaining portion 112 obtains a Virtual Channel Table (VCT) via the receiving portion 15, and obtains the virtual major channel number information, the sub number information, the virtual minor channel number information and the virtual name information by extracting the virtual major channel number information, the sub number information, the virtual minor channel number information, and the virtual name information from information included in the obtained VCT.

At this point, in the VCT, “major_channel_number” which corresponds to the virtual major channel number information, “num_channels_in_section” which corresponds to the sub number information, “minor_channel_number” which corresponds to the virtual minor channel number information, and “short_name” which corresponds to the virtual name information, are included (See, ATSC Standard: Program and System Information Protocol for Terrestrial Broadcast and Cable (Revision C) A/65c 2 Jan. 2006).

In case where it is judged by the number judging portion 113 that the sub number information which is obtained by the virtual information obtaining portion 112, does not agree with the number of the sub channels which is stored in the channel storage portion 121, the virtual information obtaining portion 112 obtains via the receiving portion 15 the virtual minor channel number information which corresponds to the sub channel that is included in the physical channel which is set by the channel setting portion 111.

The number judging portion 113 (corresponding to a number judging unit) judges whether or not the virtual major channel number information, the virtual minor channel number information, and the virtual name information which are obtained by the virtual information obtaining portion 112, agree respectively with the virtual major channel number information, the virtual minor channel number information, and the virtual name information which are stored in the channel storage portion 121. Further, the number judging portion 113 judges whether or not the sub number information which is obtained by the virtual information obtaining portion 112 agrees with the number of sub channels which is stored in the channel storage portion 121.

The number updating portion 114 (corresponding to a number updating unit) writes the virtual major channel number information which is obtained by the virtual information obtaining portion 112 in the channel storage portion 121 and updates the channel map in case where it is judged by the number judging portion 113 that the virtual major channel number information does not agree with the virtual major channel number information which is stored in the channel storage portion 121.

Further, the number updating portion 114 writes the virtual minor channel number information which is obtained by the virtual information obtaining portion 112 in the channel storage portion 121 and updates the channel map in case where it is judged by the number judging portion 113 that the sub number information does not agree with the number of sub channels which is stored in the channel storage portion 121.

Still further, the number updating portion 114 writes the virtual minor channel number information which is obtained by the virtual information obtaining portion 112 in the channel storage portion 121 and updates the channel map in case where it is judge by the number judging portion 113 that the virtual minor channel number information does not agree with the virtual minor channel number information which is stored in the channel storage portion 121.

In addition, the number updating portion 114 writes the virtual name information which is obtained by the virtual information obtaining portion 112 in the channel storage portion 121 and updates the channel map in case where it is judged by the number judging portion 113 that the virtual name information does not agree with the virtual name information which is stored in the channel storage portion 121.

The updating process ordering portion 115 (corresponding to an updating process ordering unit) displays on the display 21 information that urges user to execute a process for updating the whole channel map (for example, above described Auto Scan Process) that is stored in the channel storage portion 121 in case where it is judged by the number judging portion 113 that at least one of information of the virtual major channel number information, the virtual minor channel number information, and the virtual name information which are obtained by the virtual information obtaining portion 112, does not respectively agree with the virtual major channel number information, the virtual minor channel number information, and the virtual name information which are stored in the channel storage portion 121.

Further, the updating process ordering portion 115 displays on the display 21 information that urges user to execute the process for updating the whole channel map (for example, above described Auto Scan Process) that is stored in the channel storage portion 121 in case where it is judged by the number judging portion 113 that sub number information does not agree with the number of the sub channels which is stored in the channel storage portion 121.

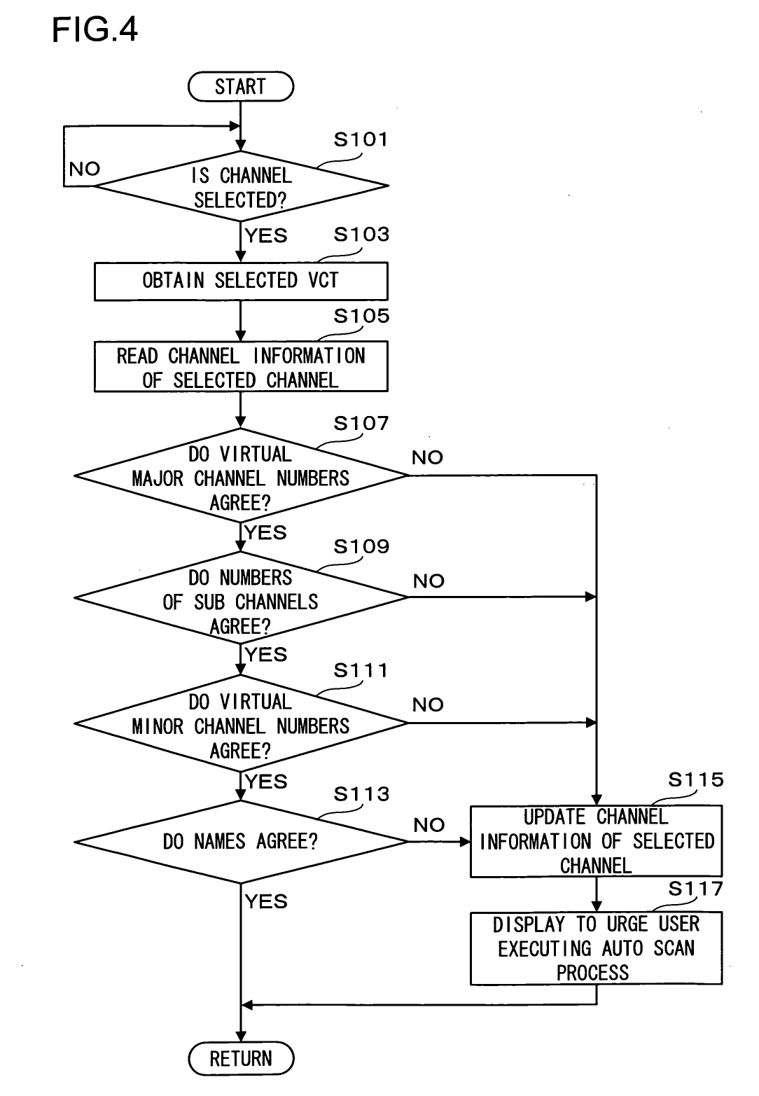

FIG. 4 is a flow chart to show one example of an operation of the digital broadcasting receiver 1 (mainly the MPU 11) according to one embodiment of the present invention. In the present embodiment, an explanation will be given about a case where the physical number information, the sub number information, the virtual major channel number information, the virtual minor channel number information, and the virtual name information, are stored in advance in the channel storage portion 121 as the channel map in corresponded manner with each other for the sake of convenience. First, judgment whether or not a channel is set is executeed by the channel setting portion 111 (S101). In case where it is judged that any channel is not set yet, (No in S101), the process is made in a standby state.

In case where it is judged that a channel is set (YES in S101), the VCT is obtained via the receiving portion 15 by the virtual information obtaining portion 112 (S103). Then, the virtual major channel number information, the virtual minor channel number information, and the virtual name information (hereinafter these are referred to as “channel information”) which correspond to the channel that is set in step S101 are read out from the channel storage portion 121 by the number judging portion 113 (S105).

Next, by the number judging portion 113, judgment is executeed whether or not the virtual major channel number information which is extracted from the VCT that is obtained in step S103 agrees with the virtual major channel number information which is read out in step S105 (S107). In case where it is judged that these information do not agree with each other (NO in S107), the process proceeds to step S115. In case where it is judged that these information agree with each other (YES in S107), by the number judging portion 113 judgment is executeed whether or not the sub number information which is extracted from the VCT obtained in step S103, agrees with the number of sub channels which is read out in step S105 (S109).

In case where it is judged that these information do not agree with each other (NO in S109), the process proceeds to step S115. In case where it is judged that these information agree with each other (YES in S109), by the number judging portion 113 judgment is executeed whether or not the virtual minor channel number information which is extracted from the VCT obtained in step S103, agrees with the virtual minor channel number information which is read out in step S105 (S111). In case where it is judged that these information do not agree with each other (NO in S111), the process proceeds to step S115. In case where it is judged that these information agree with each other (YES in S111), by the number judging portion 113 judgment is executeed whether or not the virtual name information which is extracted from the VCT obtained in step S103, agrees with the virtual name information which is read out in step S105 (S113). In case where it is judged that these information do not agree with each other (NO in S113), the process proceeds to step S115. In case where it is judged that these information agree with each other (YES in S113), the process is returned.

In cases where NO in step S107, NO in step S109, NO in step S111, or NO in step S113, the channel information (the virtual major channel number information, the virtual minor channel number information, and the virtual name information) of the channel which is set in step S101, is updated by the number updating portion 114 (S115). Then, by the updating process ordering portion 115, information that urges user to execute the process for updating the whole channel map that is stored in the channel storage portion 121, is displayed on the display 21 (S117), and the process is returned.

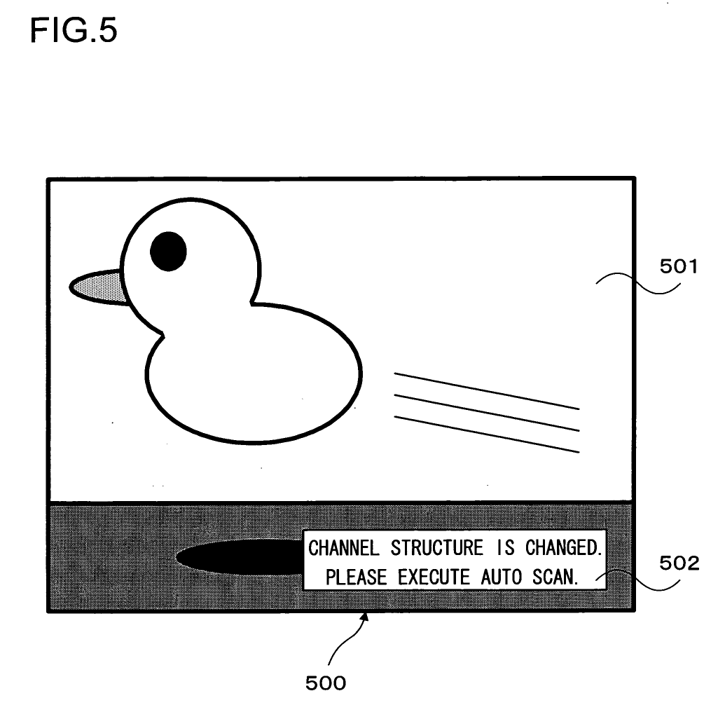

FIG. 5 is a diagram of a screen to show one example of a screen to order updating which is displayed on the display 21 in step S117 of the flow chart shown in FIG. 4. On the updating ordering screen 500, a video display portion 501 is displayed on whole screen, and a guidance display portion 502 is displayed on right lower side of the screen. The video display portion 501 displays a video image which is received via the receiving portion 15. The guidance display portion 502 displays information which urges user to execute the process for updating the whole channel map which is stored in the channel storage portion 121. In the present embodiment guidance information such as “Channel structure is changed. Please execute Auto Scan.” is displayed. By viewing this guidance information which is displayed on the guidance display portion 502, user executes Auto Scan in desired timing (for example, in late at night when television programs are not viewed) and can update the whole channel map that is stored in the channel storage portion 121.

As above described, in the channel storage portion 121 the physical number information which is numerical information to identify the receivable physical channel, the sub number information which is numerical information to identify the sub channel included in the physical channel, the virtual major channel number information which is numerical information of a virtual channel that corresponds to the physical channel, and the virtual minor channel number information which is numerical information of a virtual channel that corresponds to the sub channel are stored in advance as the channel map in which these information are arranged in corresponded manner with each other. Then the operating input from the user is received via the remote controller 3, and based on the received operating input, broadcast of the physical channel is received via the receiving portion 15 to obtain the virtual major channel number information which corresponds to the physical channel. Further, the virtual major channel number information which is obtained, is judged whether or not it agrees with the virtual major channel number information which is stored in the channel storage portion 121. In case where it is judged that these information do not agree with each other, because the obtained virtual major channel number information is written in the channel storage portion 121 and the channel map is updated, in adequate timing the channel structure can be updated.

That is, in case where it is judged that the virtual major channel number information which is obtained does not agree with the virtual major channel number information which is stored in the channel storage portion 121, the obtained virtual major channel number information is written in the channel storage portion 121 and the channel map is updated. As a result, because it is not necessary for user to order the process for updating the virtual major channel number information which is included in the channel map, the channel structure can be updated in adequate timing.

Further, because the VCT is obtained via the receiving portion 15, and the virtual major channel number information is obtained by extracting the virtual major channel number information from information which is included in the obtained VCT, the channel structure can be easily updated in adequate timing.

That is, because the virtual major channel number information is included in the VCT, the VCT is obtained, and the virtual major channel number information can be obtained by extracting the virtual major channel number information from information which is contained in the obtained VCT. As a result the virtual major channel number information can be easily obtained.

In addition, the sub number information which indicates number of sub channels that are included in the set physical channel, is obtained, and it is judged whether or not number of sub channels which is indicated by the obtained sub number information agrees with the number of sub channels which is stored in the channel storage portion 121. Because in case where it is judged that these information do not agree with each other, the virtual minor channel number information which corresponds to the sub channel that is included in the physical channel, is obtained, and the obtained virtual minor channel number information is written in the channel storage portion 121, and the channel map is updated, the channel structure can be updated in more adequate timing.

That is, in case where it is judged that the number of sub channels which is indicated by the obtained sub number information, does not agree with the number of the sub channels which is stored in the channel storage portion 121, the virtual minor channel number information which corresponds to the sub channel that is included in the physical channel, is obtained, the obtained virtual minor channel number information is written in the channel storage portion 121 and the channel map is updated. As a result, it is not necessary for the user to order the process for updating the virtual minor channel number information that is included in the channel map, the channel structure can be updated in more adequate timing.

In addition, the virtual minor channel number information which corresponds to the sub channel that is included in the set physical channel, is obtained, and it is judged whether or not the obtained virtual minor channel number information agrees with the virtual minor channel number information which is stored in the channel storage portion 121. In case where these number information do not agree with each other, because the obtained virtual minor channel number information is written in the channel storage portion 121, and the channel map is updated, the channel structure can be updated in more adequate timing.

That is, in case where it is judged that the obtained virtual minor channel number information does not agree with the virtual minor channel number information which is stored in the channel storage portion 121, the obtained virtual minor channel number information is written in the channel storage portion 121 and the channel map is updated. As a result, it is not necessary for the user to order the process for updating the virtual minor channel number information that is included in the channel map, therefore, the channel structure can be updated in more adequate timing.

Further, the virtual name information which is name information of the virtual channel that corresponds to the sub channel is stored in advance in the channel storage portion 121 in corresponded manner. Then, the virtual name information which corresponds to the sub channel that is included in the set physical channel, is obtained, and it is judged whether or not the obtained virtual name information agrees with virtual name information which is stored in the channel storage portion 121. In case where it is judged that these information do not agree with each other, because the obtained virtual name information is written in the channel storage portion 121 and the channel map is updated, the channel structure can be updated in more adequate timing.

That is, in case where it is judged that the obtained virtual name information does not agree with the virtual name information which is stored in the channel storage portion 121, the obtained virtual name information is written in the channel storage portion 121 and the channel map is updated. As a result, it is not necessary for the user to order the process for updating the virtual name information that is included in the channel map, therefore, the channel structure can be updated in more adequate timing.

In addition, in case where it is judged that the obtained information does not agree with the information which is stored in the channel storage portion 121, information which urges user to execute the process for updating the channel map which is stored in the channel storage portion 121, is displayed on the display 21 (See, FIG. 5). As a result the whole channel map can be updated in adequate timing.

That is, in case where it is judged that the obtained information does not agree with the information which is stored in the channel storage portion 121, information which urges user to execute the process for updating the whole channel map which is stored in the channel storage portion 121, is displayed on the display 21. As a result, the user can view the timing to execute the process for updating the whole channel map, therefore, the whole channel map can be updated in adequate timing.

It should be noted that the present invention can be applied in below described aspects.

(A) In the present embodiment the explanation was given about the case where the digital broadcasting receiving apparatus is the digital broadcasting receiver 1 which receives the television program in digital method. However, the digital broadcasting receiving apparatus may receive both of the television program in a digital method and the television program in an analog method.

(B) In the present embodiment the explanation was given about the case where the MPU 11 is provided with the function portions such as the channel setting portion 111, the virtual information obtaining portion 112, the number judging portion 113, the number updating portion 114, the updating process ordering portion 115 and the like as the function portions. However, at least one of the function portions among the virtual information obtaining portion 112, the number judging portion 113, the number updating portion 114, and the updating process ordering portion 115 may be realized by a hardware such as a circuit or the like.

(C) In the present embodiment the explanation was given about the case where the number judging portion 113 judges whether or not the virtual major channel number information, the virtual minor channel number information, and the virtual name information which are obtained by the virtual information obtaining portion 112 agree respectively with the virtual major channel number information, the virtual minor channel number information, and the virtual name information which are stored in the channel storage portion 121, and at the same time the number judging portion 113 judges whether or not the sub number information which is obtained by the virtual information obtaining portion 112 agrees with the number of the sub channels which is stored in the channel storage portion 121. The number judging portion 113 may judge whether or not at least one of information among the virtual major channel number information, the virtual minor channel number information, the sub number information, and the virtual name information which are obtained by the virtual information obtaining portion 112 agree with information which is stored in the channel storage portion 121.

For example, the number judging portion 113 may judges whether or not the virtual major channel number information which is obtained by the virtual information obtaining portion 112 agree with the virtual major channel number information which is stored in the channel storage portion 121. Further, for example, the number judging portion 113 may judge whether or not the virtual major channel number information and the virtual minor channel number information which are obtained by the virtual information obtaining portion 112 agree respectively with the virtual major channel number information and the virtual minor channel number information which are stored in the channel storage portion 121.

(D) In the present embodiment the explanation was given about the case where the number judging portion 113 judges that two compared information do not agree with each other, and the information which urges user to execute the process for updating the whole channel map which is stored in the channel storage portion 121, is displayed on the display 21 by the updating process ordering portion 115. However, in case where the number judging portion 113 judges that two compared information do not agree with each other, the updating process ordering portion 115 may perform the process for updating the whole channel map which is stored in the channel storage portion 121 in a prescribed timing (for example, in late at night when television programs are not viewed).

What is claimed is:

1. A digital broadcasting receiving apparatus which is connected in communicatable manner with a monitor, receives a television program in digital method, and outputs the received video information to the monitor in visible form from outside, comprising:
a channel storage unit which stores in advance physical number information which is numerical information to identify a receivable physical channel, sub number information which is numerical information to identify sub channel included in the physical channel, virtual major channel number information which is numerical information of a virtual channel that corresponds to the physical channel, and virtual minor channel number information which is numerical information of a virtual channel that corresponds to the sub channel, as a channel map in which these information are arranged in corresponded manner with each other;
a receiving unit that receives a television program in digital method;
a channel setting unit which receives an operating input from outside, and sets a physical channel which is received via the receiving unit based on the received operating input;
a virtual information obtaining unit which obtains the virtual major channel number information that corresponds to the physical channel which is set by the channel setting unit via the receiving unit;
a number judging unit which judges whether or not the virtual major channel number information which is obtained by the virtual information obtaining unit, agrees with the virtual major channel number information which is stored in the channel storage unit; and
a number updating unit which writes the virtual major channel number information which is obtained by the virtual information obtaining unit in the channel storage unit and updates the channel map in case where it is judged by the number judging unit that these virtual major channel number information do not agree with each other.

2. The digital broadcasting receiving apparatus according to claim 1, wherein the virtual information obtaining unit obtains a Virtual Channel Table (VCT) via the receiving unit, and obtains the virtual major channel number information by extracting the virtual major channel number information from information included in the obtained VCT.

3. The digital broadcasting receiving apparatus according to claim 1, wherein
the virtual information obtaining unit obtains sub number information which indicates number of sub channels which are included in the physical channel that is set by the channel setting unit,
the number judging unit judges whether or not the number of the sub channels which is indicated by the sub number information that is obtained by the virtual information obtaining unit, agrees with the number of the sub channels which is stored in the channel storage unit,
in case where it is judged by the number judging unit that the numbers of the sub channels do not agree with each other, the virtual information obtaining unit obtains virtual minor channel number information which corresponds to the sub channel that is included in the physical channel, and
the number updating unit writes the virtual minor channel number information which is obtained by the virtual information obtaining unit in the channel storage unit and updates the channel map.

4. The digital broadcasting receiving apparatus according to claim 2, wherein
the virtual information obtaining unit obtains sub number information which indicates number of sub channels which are included in the physical channel that is set by the channel setting unit,
the number judging unit judges whether or not the number of the sub channels which is indicated by the sub number information that is obtained by the virtual information obtaining unit, agrees with the number of the sub channels which is stored in the channel storage unit,
in case where it is judged by the number judging unit that the numbers of the sub channels do not agree with each other, the virtual information obtaining unit obtains virtual minor channel number information which corresponds to the sub channel that is included in the physical channel, and
the number updating unit writes the virtual minor channel number information which is obtained by the virtual information obtaining unit in the channel storage unit and updates the channel map.

5. The digital broadcasting receiving apparatus according to claim 1, wherein
the virtual information obtaining unit obtains virtual minor channel number information which corresponds to the sub channels which are included in the physical channel that is set by the channel setting unit,
the number judging unit judges whether or not the virtual minor channel number information that is obtained by the virtual information obtaining unit, agrees with the virtual minor channel number information which is stored in the channel storage unit,
in case where it is judged by the number judging unit that these virtual minor channel number information do not agree with each other, the number updating unit writes the virtual minor channel number information which is obtained by the virtual information obtaining unit in the channel storage unit and updates the channel map.

6. The digital broadcasting receiving apparatus according to claim 2, wherein
the virtual information obtaining unit obtains virtual minor channel number information which corresponds to the sub channels which are included in the physical channel that is set by the channel setting unit,
the number judging unit judges whether or not the virtual minor channel number information that is obtained by the virtual information obtaining unit, agrees with the virtual minor channel number information which is stored in the channel storage unit,
in case where it is judged by the number judging unit that these virtual minor channel number information do not agree with each other, the number updating unit writes the virtual minor channel number information which is obtained by the virtual information obtaining unit in the channel storage unit and updates the channel map.

7. The digital broadcasting receiving apparatus according to claim 3, wherein
the virtual information obtaining unit obtains virtual minor channel number information which corresponds to the sub channels which are included in the physical channel that is set by the channel setting unit,
the number judging unit judges whether or not the virtual minor channel number information that is obtained by the virtual information obtaining unit, agrees with the virtual minor channel number information which is stored in the channel storage unit,
in case where it is judged by the number judging unit that these virtual minor channel number information do not agree with each other, the number updating unit writes the virtual minor channel number information which is obtained by the virtual information obtaining unit in the channel storage unit and updates the channel map.

8. The digital broadcasting receiving apparatus according to claim 1, wherein
the channel storage unit stores in advance virtual name information which is name information of a virtual channel that corresponds to the sub channel in corresponded manner with each other,
the virtual information obtaining unit obtains virtual name information which corresponds to the sub channel that is included in the physical channel which is set by the channel setting unit,
the number judging unit judges whether or not the virtual name information which is obtained by the virtual information obtaining unit, agrees with virtual name information which is stored in the channel storage unit, and
in case where it is judged by the number judging unit that these virtual name information do not agree with each other, the number updating unit writes the virtual name information which is obtained by the virtual information obtaining unit in the channel storage unit and updates the channel map.

9. The digital broadcasting receiving apparatus according to claim 2, wherein
the channel storage unit stores in advance virtual name information which is name information of a virtual channel that corresponds to the sub channel in corresponded manner with each other,
the virtual information obtaining unit obtains virtual name information which corresponds to the sub channel that is included in the physical channel which is set by the channel setting unit,
the number judging unit judges whether or not the virtual name information which is obtained by the virtual information obtaining unit, agrees with virtual name information which is stored in the channel storage unit, and
in case where it is judged by the number judging unit that these virtual name information do not agree with each other, the number updating unit writes the virtual name information which is obtained by the virtual information obtaining unit in the channel storage unit and updates the channel map.

10. The digital broadcasting receiving apparatus according to claim 3, wherein
the channel storage unit stores in advance virtual name information which is name information of a virtual channel that corresponds to the sub channel in corresponded manner with each other,
the virtual information obtaining unit obtains virtual name information which corresponds to the sub channel that is included in the physical channel which is set by the channel setting unit,
the number judging unit judges whether or not the virtual name information which is obtained by the virtual information obtaining unit, agrees with virtual name information which is stored in the channel storage unit, and
in case where it is judged by the number judging unit that these virtual name information do not agree with each other, the number updating unit writes the virtual name information which is obtained by the virtual information obtaining unit in the channel storage unit and updates the channel map.

11. The digital broadcasting receiving apparatus according to claim 4, wherein
the channel storage unit stores in advance virtual name information which is name information of a virtual channel that corresponds to the sub channel in corresponded manner with each other,
the virtual information obtaining unit obtains virtual name information which corresponds to the sub channel that is included in the physical channel which is set by the channel setting unit,
the number judging unit judges whether or not the virtual name information which is obtained by the virtual information obtaining unit, agrees with virtual name information which is stored in the channel storage unit, and
in case where it is judged by the number judging unit that these virtual name information do not agree with each other, the number updating unit writes the virtual name information which is obtained by the virtual information obtaining unit in the channel storage unit and updates the channel map.

12. The digital broadcasting receiving apparatus according to claim 1, further comprising an updating process ordering unit which displays information that urges user to execute a process for updating the whole channel map that is stored in the channel storage unit on the monitor in case where it is judged by the number judging unit that these information do not agree with each other.

13. The digital broadcasting receiving apparatus according to claim 2, further comprising an updating process ordering unit which displays information that urges user to execute a process for updating the whole channel map that is stored in the channel storage unit on the monitor in case where it is judged by the number judging unit that these information do not agree with each other.

14. The digital broadcasting receiving apparatus according to claim 3, further comprising an updating process ordering unit which displays information that urges user to execute a process for updating the whole channel map that is stored in the channel storage unit on the monitor in case where it is judged by the number judging unit that these information do not agree with each other.

15. The digital broadcasting receiving apparatus according to claim 4, further comprising an updating process ordering unit which displays information that urges user to execute a process for updating the whole channel map that is stored in the channel storage unit on the monitor in case where it is judged by the number judging unit that these information do not agree with each other.

16. The digital broadcasting receiving apparatus according to claim 5, further comprising an updating process ordering unit which displays information that urges user to execute a process for updating the whole channel map that is stored in the channel storage unit on the monitor in case where it is judged by the number judging unit that these information do not agree with each other.
